(19) United States
(12) Patent Application Publication
(10) Pub. No.: US 2024/0382033 A1
(43) Pub. Date: Nov. 21, 2024

(54) BREWING UNIT WITH IMPROVED HOLDING STRUCTURE, AND METHOD FOR OPERATING SUCH A BREWING UNIT

(71) Applicant: EUGSTER / FRISMAG AG, Amriswil (CH)

(72) Inventors: Wolfgang Riessbeck, Landschlacht (CH); Patrick Egger, Niederbüren (CH); Yves Hug, Chur (CH)

(73) Assignee: EUGSTER / FRISMAG AG, Amriswil (CH)

(21) Appl. No.: 18/689,928

(22) PCT Filed: Jun. 28, 2022
(86) PCT No.: PCT/EP2022/067755

§ 371 Date: Mar. 7, 2024

(30) Foreign Application Priority Data
Sep. 10, 2021 (DE) 102021123549.9
Oct. 4, 2021 (DE) 102021125679.8

(51) Int. Cl. A47J 31/36

(52) U.S. Cl. CPC A47J 31/3633; A47J 31/3638

(57) ABSTRACT

The invention relates to a brewing unit (01) for a beverage preparation device, in particular for a coffee machine for substrate portions, in particular pre-portioned coffee units, comprising a support (04) and a brewing chamber (11), which has at least two brewing chamber halves (02, 03) that can be moved relative to each other in a first direction (05) and which comprises a movable holding structure (08) that is arranged so as to contact/support a fixed substrate portion such that, depending on the relative arrangement of the brewing chamber halves (02, 03), the holding structure (08) can be moved between positions between the brewing chamber halves (02, 03) and above the brewing chamber halves (02, 03). The invention is characterized in that the holding structure (08) is connected to the support (04) via a control (12) such that the holding structure (08) is arranged between the brewing chamber halves (02, 03) in an open arrangement of the brewing chamber halves (02, 03) and the holding structure (08) is arranged above the brewing chamber halves (02, 03) in a closed arrangement of the brewing chamber halves (02, 03).

### BACKGROUND OF THE INVENTION

The present invention relates to a brewing unit for a beverage preparation device for substrate portions, in particular for a coffee machine for pre-portioned coffee units. Furthermore, the present invention relates to a method for operating a brewing unit for a beverage preparation device for substrate portions, in particular for a coffee machine for pre-portioned coffee units.

Various brewing units which are used for processing pre-packaged substrate portions, in particular coffee units, are known from the prior art. The substrate portions or coffee units can also be referred to as capsules, in which a certain amount of air is encapsulated in addition to the beverage substrate, in particular the coffee bean powder or coffee powder, the encapsulation generally being achieved by a capsule shell or capsule material. Different geometries and shapes and different materials are known for such substrate portions and, based on or resulting from this, a wide variety of brewing units and methods for handling or methods for operating said brewing units, all of which must provide the following basic functionalities:

First, the substrate portion must be introduced into the brewing unit. Depending on the design of the substrate portion, a more or less precisely defined orientation and position of the substrate portion may be necessary at the end of the introduction or insertion process in order to be able to subsequently process the substrate portion further with the brewing unit. After the substrate portion has been received or inserted, it must generally be ensured or achieved that the brewing unit at least temporarily forms a closed and/or sealed brewing chamber around the substrate portion, which is typically ensured by brewing-chamber parts or brewing-chamber halves disposed in such a manner that they can move relative to each other and/or relative to a support.

During or after the closing and sealing of the brewing chamber, suitable access to the beverage substrate, in particular coffee bean powder or coffee powder, must then be created inside the capsule or the substrate portion. In the prior art, this is usually made possible by piercing or opening part of the substrate portion. A brewing process should then take place in a still closed and sealed state of the brewing chamber by introducing a brewing fluid, preferably hot water, into the brewing chamber and thus into the substrate portion in order to leach out, in particular brew, the beverage substrate.

The beverage brewed in this manner must be discharged from the brewing chamber and subsequently also from the brewing unit and the beverage preparation device. After a brewing process has been carried out, the used or depleted substrate portion, in particular coffee unit, must be removed from the brewing unit, in particular from the brewing chamber, and disposed of, which is usually done by opening the brewing-chamber halves or brewing-chamber parts, which can be moved relative to each other, and expelling, scraping or otherwise ejecting the used substrate portion.

Finally, the brewing unit is moved to a position or starting position in which another process as described above can be carried out again.

In the approaches known to date, the first part of the process described above in particular has led to various problems prior to the closing of the brewing-chamber parts or brewing-chamber halves. After all, the necessity of receiving or accommodating the substrate portion in an open state of the brewing-chamber halves and at the same time of transferring it to a state which permits further processing, in particular closing, sealing and brewing in the brewing chamber, has led to solutions of holding structures or devices for capsule management which are in some cases complex and/or require a lot of installation space and which are both prone to failure and/or susceptible to incorrect operation while causing a high level of constructional effort in the manufacture of the brewing units and/or requiring relatively large quantities or volumes of installation space.

Examples of devices with such or similar capsule management or substrate portion management are known from EP 2 747 610 B1, EP 2 654 528 B1, EP 1 757 212 B1, EP 2 806 773 B1 or EP 2 405 790 B1.

WO 2017/108759 A1 discloses a brewing unit comprising a capsule guiding and capsule holding structure having a fixed component and one or two pivoting components. The pivoting component is disposed between the brewing-chamber halves when the brewing-chamber halves are open and is moved upward when they are closed.

WO 2012/046195 A1 describes a brewing unit comprising one or two pivoting capsule guiding structures, which are disposed between the brewing-chamber halves when the brewing-chamber halves are open and are positioned above the brewing chamber when the brewing-chamber halves are closed.

WO 2012/085774 A1 discloses a brewing unit comprising a pair of movable gripper structures which release a substrate capsule when the brewing-chamber halves are moved into an open position and position the capsule in the brewing chamber when they are moved into a closed position. The gripper structures are preloaded against each other and can move into a spaced-apart position.

### SUMMARY OF THE INVENTION

Against this background, the object of the present invention is to propose a brewing unit and a method for operating a brewing unit which overcome the disadvantages of the prior art and, in particular, to propose a compact brewing unit which is less susceptible to malfunction and failure and a method for its operation.

This object is attained with a brewing unit having the features as disclosed herein. Furthermore, this object is attained with a method for operating a brewing unit according to the features also as disclosed herein.

Advantageous embodiments of the invention are the subject of the following description, the description of the figures, the figures and the dependent claims.

The brewing unit according to the invention for a beverage preparation device for substrate portions, in particular for a coffee machine for coffee units, comprises a support for receiving and guiding brewing-unit assemblies and brewing-unit elements comprising a brewing chamber, the brewing chamber having at least two brewing-chamber halves configured to move relative to each other and/or relative to the support in a first direction and a movable holding structure disposed and or configured in such a manner to contact/support a solid substrate portion that the holding structure can be moved between the brewing-chamber halves and above the brewing-chamber halves as a function of the relative position of the brewing-chamber halves. According to the invention, the holding structure is connected to the support via control means in such a manner that the holding structure is disposed between the brewing-chamber halves when the brewing-chamber halves are open and the holding structure is disposed above the brewing-chamber halves when the brewing-chamber halves are closed.

The invention is based on the basic idea that the holding structure, which receives and/or holds the substrate portion before the brewing-chamber halves are closed, is moved upward or to a position above the brewing chamber when the brewing-chamber halves are closed or sealed and, conversely, is moved back into a space between the brewing-chamber halves from above or from above the brewing-chamber halves when the brewing-chamber halves are opened. This configuration and design allows an equally simple and compact design of the holding structure and the control means, which control the movement of the holding structure or cause it to move depending on the relative position of the brewing-chamber halves. It is particularly advantageous that in the proposed design of the holding structure, the weight of the holding structure and the movement or relative movement of the brewing-chamber halves, which takes place anyway, can support and/or cause the movement of the holding structure.

In the case at hand, the term brewing-chamber half is not to be understood in a mathematical sense of an exact half of a whole but is intended to stress the fact that two brewing-chamber halves are provided in order to form the sealable brewing chamber.

According to the invention, the holding structure is configured in such a manner that no preferred direction or preferred orientation of the substrate portion is effected or defined by the holding structure. In other words, the substrate portion can be placed on or transferred to the holding structure in a plurality of orientations, particularly preferably in any orientation.

Furthermore, the substrate portion can advantageously be further processed in a corresponding plurality of orientations. In a likewise particularly advantageous manner, the brewing unit and/or the beverage preparation device, for its part, can also be guide-free in an introduction area or in an insertion area of the substrate portion to the extent that, while directional guidance of the substrate portion toward the holding structure is ensured, for example via an insertion channel or an introduction rail, the guidance of the substrate portion toward the holding structure is otherwise free or unbound and/or unguided, so that no guidance of the substrate portion with respect to its orientation or alignment in relation to the brewing unit and/or the beverage preparation device takes place or is effected.

Advantageously, a brewing-chamber half can be fixedly or immovably disposed on the support, and a second brewing-chamber half can be connected to the support in a movable manner, in particular in such a manner that it can be shifted along a first direction, so that the movable brewing-chamber half is moved toward and away from the brewing-chamber half immovably connected to the support when the brewing chamber is opened and closed.

However, the fact that a brewing-chamber half is preferably disposed in a fixed position relative to the support does not mean that said brewing-chamber half cannot have any moving parts or elements. For example, the brewing-chamber half configured to move relative to the support can have piercing or ejection features, which in turn can be configured to move relative to the brewing-chamber half and thus also relative to the support.

The movement of the brewing-chamber half which is advantageously mounted in such a manner that it can move relative to the support can advantageously be achieved by a drive. Mechanical, electric or electromotive, hydraulic drive principles can be employed and/or combined in this regard. Furthermore, part of the movements of the preferably one movable brewing-chamber half can advantageously be carried out automatically, for example by using energy or force storage means, in particular spring elements, which are preloaded, compressed or charged during part of the movements in order to then automatically cause a movement during another part of the movement or movements. An automatic opening of the brewing-chamber halves can be realized in a particularly advantageous manner by using preloaded energy or force storage means.

According to an advantageous embodiment of the brewing unit, the holding structure can comprise two holding elements which are connected to the control means. The two holding elements can advantageously be disposed next to each other in a direction perpendicular to the first direction, preferably next to each other along a width extension of the brewing unit. Further advantageously, the holding elements can be connected to the control means in such a manner that the holding elements are moved or displaced, i.e., positioned between the brewing-chamber halves and/or raised above the brewing-chamber halves or lowered, simultaneously and essentially synchronously.

The use of two holding elements, which are preferably disposed next to each other in a width direction and further preferably at a certain distance or intermediate distance from each other, enables the substrate portion, in particular coffee unit, to be held securely and reliably while requiring relatively little material and, accordingly, relatively small masses to be moved and accelerated when closing and opening the brewing-chamber halves. In addition, when two holding elements are present, easy transfer of the substrate portion to or onto the brewing-chamber halves when closing the brewing-chamber halves can be achieved.

Advantageously, the control means can further be designed as two separate control elements, each of which is preferably connected to a holding element. The control elements can also preferably be disposed and/or realized next to each other in a width direction of the brewing unit and preferably spaced apart from each other or separated from each other by a gap. The mass and the inertia of the holding structure and the control elements connected to it are also advantageously reduced for the two separate and preferably disposed separately and/or spaced apart control elements. In addition, this facilitates the transfer of the substrate portion when closing the brewing-chamber halves.

According to another, particularly advantageous embodiment of the brewing unit, the control means, in particular control elements, can be attached, in particular connected at one end, to an axis which is rotatably connected to the support, wherein the axis is preloaded in a first direction of rotation, preferably via preload means, in particular spring means.

The axis can preferably be disposed above the brewing-chamber halves on a side of the support that faces away from a fixedly disposed brewing-chamber half or toward a movably disposed brewing-chamber half. Preferably, the axis can extend in the direction of the width of the brewing unit and thus at a right angle to the first direction of movement of the brewing-chamber halves. In a particularly advantageous manner, the axis allows the control means which are attached to it, in particular connected to the axis at one end, to be pivoted or rotated about the axis, which advantageously has the result that the holding structure or the holding elements can also be pivoted or rotated essentially about the axis, in particular if the holding structure, in particular the holding elements, is/are disposed or formed at the other end of the control means or control elements.

The advantageous preload can, for example, either reinforce or counteract the effect of gravity on the holding structure and/or control means. Depending on the direction in which the axis is preloaded, the other actuation or control of the control means must ensure that the holding structure is either raised against the preload of the axis when the brewing-chamber halves are closed or, alternatively, lowered against the preload when the brewing-chamber halves are opened.

As will be described in more detail below, when the axis is disposed above a movable brewing-chamber half, it has proved to be particularly advantageous to realize a preload which preloads the axis in such a manner that the control means and/or the holding structure are preloaded to support the effect of gravity and thus essentially downward, so that the preload supports the lowering of the holding structure when the brewing-chamber halves are opened.

According to an advantageous embodiment, the control means, in particular the control elements, has/have a lower control surface which comes into contact with an upper edge of a preferably movable brewing-chamber half, the edge preferably extending essentially at a right angle to the first direction, in particular in the width direction of the brewing unit, the control surface sliding along the edge during a movement of the brewing-chamber half. The formation of such an edge or control edge on the upper side of a preferably movable brewing-chamber half has various advantages; for example, it enables direct and automatic actuation of the control means, in particular the control elements. At the same time, the drive of the control means or control elements is caused indirectly by the movement of the brewing-chamber half in relation to the control means or the control elements. This embodiment can be combined particularly advantageously with the embodiment in which the control means or the control elements are pivotably or rotatably connected to an axis disposed above the brewing-chamber halves and mounted in the width direction in such a manner that it can rotate relative to the support. However, it may also be particularly advantageous in another context for the control elements or the control means to be control arms which are connected to the holding structure or the holding elements at one end and to the support at the other end, for example via the said axis. It may also be particularly advantageous for the control elements and the holding elements to be a one-piece/single-part, preferably monolithic, component.

When the preferably movable brewing-chamber half moves toward the axis or at least a front end or an end of the movable brewing-chamber half facing the other brewing-chamber half approaches the axis, the control arms then allow that a shortening of the distance between the axis and the upper edge of the brewing-chamber half has the result that the control means or the control elements can be lowered and thereby the holding structure or the holding elements can be lowered into the space between the brewing-chamber halves. Conversely, a movement of the brewing-chamber half away from the axis or a comparable bearing or suspension point of the control elements has the effect that the control means or the control elements are raised and thus the holding structure or the holding elements are raised as the control elements or the control means slide along the edge of the brewing-chamber half. The edge of the brewing-chamber half can preferably be curved, in particular perpendicular to the width direction of the brewing unit, in order to enable the control elements or control means to slide as evenly as possible. The term edge can thus also be understood broadly as a contact or sliding surface.

According to another, preferred embodiment of the brewing unit, the control elements can be attached to the axis in such a manner that they can at least partially move in the axial direction of the axis and are preloaded with preload means, in particular spring means, toward an axial central section of the axis. In this context, it should first be expressed that this embodiment is not in contradiction with the embodiment according to which the control means or the control elements are rotatably connected to the axis or are disposed in such a manner that they are rotatably attached to the axis. For example, a non-detachable force fit between the control means and the axis in the direction of rotation may exist and remain in place even if the control means or the control elements are mounted in such a manner that they are movable in the longitudinal direction or the axial direction of the axis and are preferably preloaded from the outside in the direction of the center of the axis. The axial mobility of the control elements in relation to the axis or axis of rotation, for example along the longitudinal direction of groove and spring means which run along the axis on the axis and on the control elements or the control means, ensures in a particularly advantageous manner that a malfunction or incorrect operation of the brewing unit is prevented.

For example, a user or operator may accidentally insert two unused or non-depleted substrate portions into the brewing unit or, more precisely, into the beverage preparation device before initiating the brewing process and thus before closing the brewing-chamber halves. In the prior art, this can sometimes lead to malfunctions and damage. In the present embodiment, however, it is possible in this case for the operator or user to easily remove or push away a lower or first inserted substrate portion from the area between the brewing-chamber halves past the holding elements or the holding structure or from between the holding elements by applying a certain force acting downward to the upper substrate portion. This force is then sufficient to move the control elements, preferably against the preload force of the preload means, axially outward along the axis and thus further away from each other, so that the distance between the holding elements attached to the control means is also increased and the lower substrate portion can pass between the holding elements of the holding structure.

An axially movable mounting of the control elements on an axis or axis of rotation also has the advantage that the transfer of the substrate portion between the holding structure or the holding elements and the brewing-chamber halves when the brewing-chamber halves are closed is facilitated and, at the same time, a secure reception and a secure hold of the substrate portion is ensured before the brewing-chamber halves are closed.

In this context, the control elements can advantageously have an inner control surface which comes into contact with a control contour, preferably a control web, of a first, in particular movable, brewing-chamber half, the inner control surface sliding along the control contour when the brewing-chamber half moves. With such a realization of an inner control surface as part of the control elements and an associated or cooperating control contour, which is preferably part of the movable brewing-chamber half, it can be achieved that the holding elements of the holding structure are not only raised and lowered when the brewing-chamber halves are opened and closed but, at least partially or temporarily, also simultaneously widened or moved away from each other or, vice versa, toward each other in the width direction of the brewing chamber unit by following the movement of the control elements connected to them in the outward direction.

This means that, for example, the pivoting movement of the control means about the axis, which leads to the raising and lowering of the holding elements or the holding structure, can be partially superimposed with a movement of the holding elements of the holding structure away from each other or toward each other, which is caused when the control elements are moved away from each other or toward each other in the axial direction or longitudinal direction of the axis by the inner control surface and its contact with the control contour. In this manner, a state can be advantageously achieved, for example when the brewing-chamber halves are closing, in which the contacting of the substrate portion is gradually or smoothly transferred from the holding structure to the brewing-chamber halves without the movement of the brewing-chamber halves being restricted or adversely affected by the holding structure while a secure hold of the substrate portion is ensured at all times.

According to another, advantageous embodiment, the holding structure, in particular the holding elements, can comprise a support surface defined by an edge or collar on the outside and by a recess on the inside. This ensures both self-centering of the substrate portion after insertion into the beverage preparation device and/or brewing unit and secure guidance and effective transfer of the substrate portion to the brewing chamber or the brewing-chamber halves. If the holding structure is composed of two holding elements, which are preferably disposed at a distance from one another, they can each have an edge/collar and an inner recess, which means that a structure is created in which a substrate portion is disposed centrally in the area of the holding elements or centrally held between the holding elements, in particular without being aligned or guided by other guide elements or guide means.

Another particularly advantageous embodiment of the invention provides that the holding structure is configured in such a manner that when the brewing-chamber halves are in the open position, a substrate portion introduced into a space between the brewing-chamber halves in an otherwise unguided manner is automatically moved into a defined preparatory position. As already mentioned at the beginning, the design of the brewing unit and, in particular, the design of the holding structure can be significantly simplified and can be simpler and smaller both mechanically and in terms of installation space if no well-defined initial orientation or receiving orientation of the substrate portion has to be achieved. This also means that the brewing unit is preferably used to process substrate portions that have a high degree of symmetry, preferably even a complete or approximate point symmetry, for example in the form of a sphere or ball. This is because in the case of such symmetrical substrate portions, there are no or only few equivalent alignments or alignment options, which means that the guideless or unguided introduction or transfer into or to the brewing unit is possible or enables further processing of the substrate portion.

Furthermore, the holding structure, in particular the holding elements, can advantageously have a downwardly projecting scraper protrusion. In this manner, it can be advantageously realized that when the brewing-chamber halves are opened, for example after a brewing process and after the holding structure has been lowered at least temporarily or partially simultaneously from its position above the brewing-chamber halves to a position between the brewing-chamber halves, the downwardly projecting or protruding scraper protrusion applies a suitable downward force to a substrate portion still located between the brewing-chamber halves or still adhering to a brewing-chamber half and thus advantageously supports the detachment of the substrate portion and the removal of the substrate portion from the brewing unit. In the case of a monolithic design of the holding structure with the control means, in particular in the case of integrally formed holding and control elements, the scraper protrusion can also extend from the holding areas into the control areas of the combined component.

The object mentioned above is also attained by a beverage preparation device for substrate portions, in particular for a coffee machine for coffee units, with a brewing unit according to any one of the embodiments described above.

The object mentioned above is also attained by a method of operating a brewing unit for a beverage preparation device for substrate portions, in particular for a coffee machine for coffee units, the brewing unit comprising a support and a brewing chamber having at least two brewing-chamber halves configured to move relative to each other in a first direction and a movable holding structure for contacting/supporting a solid substrate portion disposed in such a manner that the holding structure is moved between positions between the brewing-chamber halves and above the brewing-chamber halves as a function of the relative position of the brewing-chamber halves, in that the holding structure is connected to the support in such a manner via control means that when the brewing-chamber halves move to reach an open position, the holding structure is lowered between the brewing-chamber halves, and when the brewing-chamber halves move to reach a closed position of the brewing-chamber halves, the holding structure is raised above the brewing-chamber halves, wherein the substrate portion can be placed on or transferred to the holding structure in a plurality of orientations, particularly preferably in any orientation.

With regard to the advantages, advantageous effects and also with regard to the embodiment of the method, reference shall be made to the device according to the invention described above in order to avoid unnecessary repetition. This also means that features disclosed and claimed in the context of the device in the present disclosure are also deemed to be disclosed and claimable in the context of the method and vice versa.

In summary, the method according to the invention enables a simple, compact design of the brewing unit, and thus also of the beverage preparation device, which is not susceptible to malfunctions or operating errors.

According to an advantageous embodiment of the method, the movement of the holding structure can be effected by the synchronous and symmetrical movement of two holding elements which are connected to the control means. In this manner, as already indicated above, the transfer of the substrate portions can be achieved effectively and with little design effort and with the involvement of small masses to be accelerated. Furthermore, each holding element can advantageously be controlled by a control element comprised by the control means.

Furthermore, the control means can advantageously be subjected to a downward force irrespective of the position or the movement of the brewing-chamber halves when the control means, in particular control elements, are attached to an axis which is disposed in a fixed position relative to the support and mounted to rotate, the axis preferably being preloaded in a first direction of rotation by preload means, in particular spring means. By applying the downward force, the overhead position of control means or control elements can be used to ensure indirect control of the control elements or control means via contact with a movable brewing-chamber half, preferably with an edge thereof.

Furthermore, a lower control surface of the control means, in particular control elements, can advantageously slide along an upper edge of a brewing-chamber half during the movement of a moving brewing-chamber half. As a result, the movement of the control means, in particular control elements, can be advantageously effected or caused directly or indirectly by the movement of a movable brewing-chamber half.

Furthermore, when a movable brewing-chamber half moves, the control elements can advantageously be moved away from each other at least temporarily or partially relative to the support in the axial direction or longitudinal direction of the axis when the brewing-chamber halves move from the open position into the closed position, and be moved toward each other at least temporarily or partially when the brewing-chamber halves move from the closed position into the open position.

Furthermore, when a force is applied, in particular to a substrate position from above downward when the holding elements are in a lowered position between the open brewing-chamber halves, the holding elements can advantageously move or be moved outward in the axial direction of the axis or away from each other, preferably against a mechanical preload.

Also, a substrate portion otherwise introduced without guidance into a space between the brewing-chamber halves when the brewing-chamber halves are in the open position can advantageously be automatically transferred into a defined preparatory position, which, however, does in particular not include a preferred orientation or a defined orientation of the substrate position itself relative to the beverage preparation device or the brewing unit.

According to another, particularly advantageous embodiment of the method, a substrate portion which is still located between the brewing-chamber halves when the brewing-chamber halves are opened, preferably after a brewing process, is scraped off downward by a scraper protrusion projecting downward on the holding structure, in particular the holding elements, by lowering the holding structure from above between the opening or opened brewing-chamber halves.

### BRIEF DESCRIPTION OF THE DRAWINGS

Advantageous aspects, embodiments and details of the brewing unit according to the invention are illustrated below with reference to the merely schematic figures.

FIG. 1: is a sectional view of part of a brewing unit according to the invention with the brewing-chamber halves in an open position;

FIG. 2: is a perspective view of part of a brewing unit according to the invention with the brewing-chamber halves in a closed position;

FIG. 3: is a sectional view of part of a brewing unit according to the invention with the brewing-chamber halves in a closed position.

### DETAILED DESCRIPTION

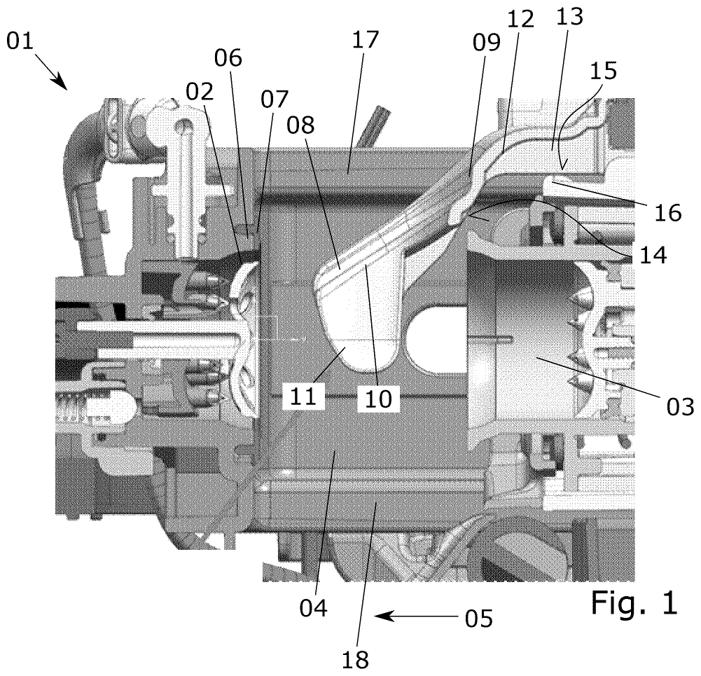

The sectional view of FIG. 1 partially shows a brewing unit 01, which has a first brewing-chamber half 02 and a second brewing-chamber half 03. The brewing-chamber halves 02, 03 are configured to move relative to each other with respect to a support 04 in such a manner that brewing-chamber half 03 can be moved toward and away from the first brewing-chamber half 02 in a first direction 05 or longitudinal direction of the brewing unit 01. To form a closed and sealed brewing chamber from the brewing-chamber halves 02, 03, a seal 07 is provided on a contact surface 06, the seal 07 sealing the brewing-chamber halves 02, 03 when they are transferred into a closed position and, if necessary, a force moving them further together is applied.

In the open configuration of FIG. 1, a holding structure 08 is disposed in a position between the brewing-chamber halves 02, 03. The holding structure 08 has a collar 09 and an inner or internal recess 10. Furthermore, the holding structure comprises a downwardly projecting scraper protrusion 11. The holding structure 08, which preferably comprises two holding elements disposed next to each other in a direction perpendicular to the drawing plane and preferably spaced apart from each other and which are mirror-symmetrical with respect to a central symmetry plane parallel to the first direction 05, are controlled via control means 12, which are connected to the support 04.

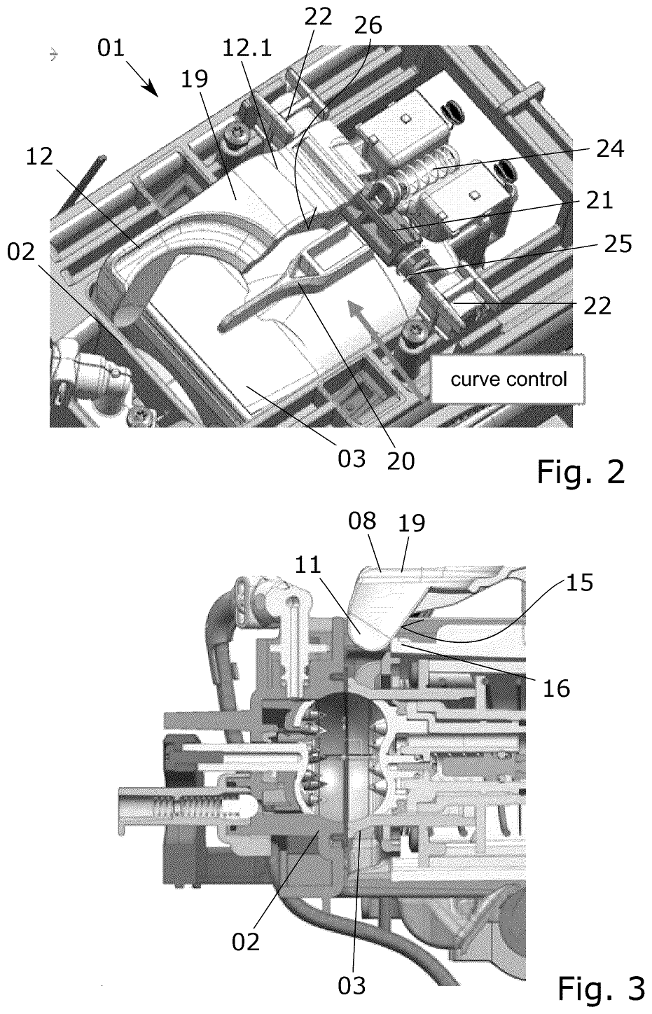

The connection between the control means 12 and the support 04 is not shown in the section of FIG. 1. In this respect, reference is made to the illustration in FIG. 2. The control means 12 can be control arms 13, which are preferably formed in one piece with the holding elements or the holding structure. The control means 12 or the separate control elements have a control surface 15 on an underside 14, the control surface 15 coming into contact with the upper edge 16 of the movable brewing-chamber half 03, the edge 16 preferably extending essentially at a right angle to the first direction 05 in the width direction of the brewing unit. It can already be seen from the illustration in FIG. 1 that when the brewing unit 03 together with the upper edge 16 moves toward the first brewing-chamber half 02, the control surface 15 of the control means 12 slides along the edge 16, and the control means 12 pivot or rotate together with the holding structure 08 upward over the brewing-chamber halves 02, 03 since the control means 12 and the holding structure 08 attached thereto or integrally connected thereto are mounted to rotate, as will be described in more detail with reference to FIG. 2.

It can also be seen in the position shown in FIG. 1 that no further guide means or guiding structures are provided; instead, a substrate portion can be introduced or inserted into the brewing unit from above through an opening 17 without being guided and is then held/supported by the holding structure 08, the recess 10 on the inside and the collar 09 on the outside defining the position of the substrate portion but not effecting an alignment or a special relative position of the substrate position with respect to the brewing unit 01 otherwise.

The function of the scraper protrusion 11 of the holding structure 08 and/or the control means 12 can also be clearly seen from the illustration in FIG. 1. If the holding structure 08 is lowered back down between the brewing-chamber halves 02, 03 from above via the control elements or control means 12, the control surface 15 again sliding along the edge 16 in the process, when the brewing-chamber halves 02, 03 are opened after a brewing process has been carried out, a substrate portion still located between the brewing-chamber halves 02, 03 can be subjected to a downward force by the scraper protrusion 10, as a result of which the substrate portion is moved in the direction of an outlet 18 or at least subjected to a force.

FIG. 2 shows a perspective illustration of part of the brewing chamber unit according to the invention when the brewing-chamber halves 02, 03 are closed. For reasons of clarity, only one holding element 19 of the holding structure 08 is shown. A second, opposite holding element is left out of the illustration in FIG. 2 in order to allow a control contour 20 to be shown. A second holding element mirrored along the longitudinal axis of the control contour 20 is advantageously provided and disposed opposite the holding element 19. The same applies to the control element 12.1 shown and the control element not shown.

The holding element 19 merges directly or integrally into the control element 12.1, which is then connected to an axis 21 in such a manner at an end facing away from the holding element that a rotation of the axis 21 is transmitted to the control element 12.1 and to the holding element 19. In the longitudinal direction, both ends of the axis 21 are accommodated in bearing points 22, which are connected to the support 04 via corresponding connecting means 23. The axis 21 is also preloaded or subjected to a force in a direction of rotation R by the preload means 24. Furthermore, preload means 25 are provided on the axis itself, which in turn preload or apply force to the control element 12.1 and the control element not shown in the direction of the center or a middle portion of the axis 21. The control elements 12.1 have an inner control surface 26, which slides along the control contour 20 when the movable brewing-chamber half 03 moves relative to the axis 21 and relative to the control element 12.1.

The mounting or attachment of the control elements 12.1 on/to the axis 21 thus ensures that a rotation of the axis is transmitted to the control elements and thus also to the holding elements 19 and that the holding elements 19 together with the control elements 12.1 can be moved simultaneously in the longitudinal direction of the axis or in the axial direction of the axis 21, the preload means 25 applying a force to the holding elements 19 via the control elements 12.1 to the center or a central area of the axis 21 in the absence of any other force action.

A force that can counteract the preload means 25 and thus cause the control elements 12.1 and the holding elements 19 to widen in the width direction is provided, for example, via the control contour 20 and its effect on the inner control surface 26. The control contour has a y-shaped contour or a v-shaped rear portion, which has the effect that when the control contour 20 slides along the inner control surface 26 and the movable brewing-chamber half 03 moves forward or toward the brewing-chamber half 02, the holding elements 19 are spread or moved away from each other by a corresponding movement of the control elements 12.1 along the axis 21 against the preload means 25. Conversely, opening the brewing chamber by moving brewing-chamber half 03 away from brewing-chamber half 02 causes the inner control surface 26 to slide along the control contour 20 again and to be transferred from the spread open V-shaped portion into the non-branched narrow front portion of the control contour 20 or to come into contact therewith, as a result of which the control elements 12. 1 and thus also the holding elements 19 move synchronously and symmetrically toward each other again in the axial direction of the axis 21 until a minimum distance between the holding elements 19 and the control elements 12.1 is reached, said minimum distance being defined by the control contour 20 and/or by corresponding internal or centrally disposed mechanical stops on the axis 21.

In the illustration of FIG. 2, it can be seen that the holding element 19 or the holding elements is/are disposed above the brewing chamber or the brewing-chamber halves when the brewing-chamber halves 02, 03 are closed. The edge 16 with which the lower control surface 15 of the control means 12, in particular the control elements 12.1, comes into contact is located in the area of the scraper protrusion 11 in the example of FIG. 2, from which it can be deduced that the control means 12 or the control elements 12.1 and in particular their lower control surface 15 can also include parts of the scraper protrusion 11 and/or parts of the holding elements 19. Conversely, this means that the scraper protrusion 11 can also or at least partially be associated with the control means 12 or the control elements 12.1 in addition to or instead of the holding elements 19 or the holding structure 08 since the lower control surface 15 extends into the area of the scraper protrusion 11.

For the sake of completeness and for comparison with FIG. 1 and the open position of the brewing-chamber halves 02, 03 shown there, a sectional view corresponding to the state of FIG. 2 is shown again in FIG. 3. In the closed position shown in FIG. 3, the brewing chamber is closed by the brewing-chamber halves 02, 03 and the holding elements 19 of the holding structure 08 and the control elements 12.1 of the control means 12 are located above the brewing-chamber halves 02, 03. FIG. 3 again clearly shows the functionality of the scraper protrusion 11, which can force or accelerate a substrate portion disposed in the brewing chamber between the brewing-chamber halves 02, 03 in the direction of an outlet 18 when the brewing-chamber halves open, in particular when brewing-chamber half 03 moves away from brewing-chamber half 02 again, the control elements 12. 1 or the control means 12 slide along the front, upper edge 16 of the brewing-chamber half 03 and both the preload of the axis 21 in the direction of rotation and the weight of the holding structure 08 and of the control means 12 ensure that the scraper protrusion 11 moves downward in the direction between the opening brewing-chamber halves 02, 03.

### REFERENCE SIGNS

01 brewing unit
02 brewing-chamber half
03 second brewing-chamber half
04 support
05 first direction
06 contact surface
07 seal
08 holding structure
09 collar
10 recess
11 scraper protrusion
12 control means
12.1 control elements
13 control arms
14 underside
15 control surface
16 edge
17 opening
18 outlet
19 holding element
20 control contour
21 axis
22 bearing points
23 connecting means
24 preload means
25 preload means
26 inner control surface
R direction of rotation

1. A brewing unit (01) for a beverage preparation device, the brewing unit (01) comprising a support (04) and a brewing chamber, the brewing chamber having at least two brewing-chamber halves (02, 03) configured to move relative to each other in a first direction (05) and a movable holding structure (08) disposed in such a manner to contact/support a solid substrate portion that the holding structure (08) can be moved between positions between the brewing-chamber halves (02, 03) and above the brewing-chamber halves (02, 03) as a function of the relative position of the brewing-chamber halves (02, 03), the holding structure (08) being connected to the support (04) in such a manner via control means (12) that when the brewing-chamber halves (02, 03) are open, the holding structure (08) is disposed between the brewing-chamber halves (02, 03), and when the brewing-chamber halves (02, 03) are closed, the holding structure (08) is disposed above the brewing-chamber halves (02, 03),
wherein
the holding structure is configured in such a manner that the holding structure does not effect or define any preferred direction or preferred orientation of the substrate portion.

2. The brewing unit (01) according to claim 1,
wherein
the holding structure (08) has two holding elements (19) connected to the control means (12).

3. The brewing unit (01) according to claim 1,
wherein
the control means (12) comprise two separate control elements (12.1), which are each connected to a holding element (19).

4. The brewing unit (01) according to claim 1,
wherein
the control means (12) are attached to an axis (21) connected to the support (4) in a rotating manner, the axis (21) being preloaded in a first direction of rotation (R) by preload means (24).

5. The brewing unit (01) according to claim 1,
wherein
the control means (12) have a lower control surface (15), which comes into contact with an upper edge (16) of a brewing-chamber half (03), the edge (16) being essentially perpendicular to the first direction (5), the control surface (15) sliding along the edge (16) when the brewing-chamber half (03) moves.

6. The brewing unit (01) according to claim 3,
wherein
the control elements (12.1) are attached to the axis in an at least partially movable manner in an axial direction of the axis (21) and are preloaded toward an axial center portion of the axis (21) by preload means (25).

7. The brewing unit (01) according to claim 3,
wherein
the control elements (12.1) have an inner control surface (26), which comes into contact with a control contour (20) of a brewing-chamber half (03), the inner control surfaces (26) sliding along the control contour (20) when the brewing-chamber half (03) moves.

8. The brewing unit (01) according to claim 1,
wherein
the holding structure (08) comprise(s) a support surface defined by an edge or a collar (09) at the outside and by a recess (10) on the inside.

9. The brewing unit (01) according to claim 1,
wherein
the holding structure (08) is configured in such a manner that when the brewing-chamber halves (02, 03) are open, a substrate portion introduced into a space between the brewing-chamber halves (02, 03) in an otherwise unguided manner is automatically moved into a defined preparatory position.

10. The brewing unit (01) according to claim 1,
wherein
the control means (12) and/or the holding structure (08) has/have a scraper protrusion (11) protruding downward.

11. A method for operating a brewing unit (01) for a beverage preparation device, in particular a coffee machine, the brewing unit (01) comprising a support (04) and a brewing chamber which has at least two brewing-chamber halves (02, 03) configured to move relative to each other in a first direction (05) and a movable holding structure (08) disposed in such a manner to contact/support a solid substrate portion that the holding structure (08) is moved between positions between the brewing-chamber halves (02, 03) and above the brewing-chamber halves (02, 03) as a function of the relative position of the brewing-chamber halves (02, 03), the holding structure (08) being connected to the support (04) in such a manner via control means (12) that when the brewing-chamber halves (02, 03) move to reach an open position, the holding structure (08) is lowered between the brewing-chamber halves (02, 03), and when the brewing-chamber halves (02, 03) move to reach a closed position of the brewing-chamber halves (02, 03), the holding structure (08) is raised above the brewing-chamber halves (02, 03),
wherein
the holding structure does not effect or define any preferred direction or preferred orientation of the substrate portion.

12. The method according to claim 11,
wherein
the movement of the holding structure (08) is effected by the synchronous and symmetrical movement of two holding elements (19) connected to the control means (12).

13. The method according to claim 11,
wherein
each holding element (19) is controlled by a control element (12.1) comprised by the control means (12).

14. The method according to claim 11,
wherein
the control means (12) are subjected to a downward force irrespective of the position or the movement of the brewing-chamber halves (02, 03) as the control means (12) are attached at one end to an axis (21) mounted to rotate relative to the support (04), the axis (21) being preloaded into a first direction of rotation (R) by preload means (24).

15. The method according to claim 11,
wherein
a lower control surface (15) of the control means (12) slides along an upper edge (16) of one brewing-chamber half (03) when one brewing-chamber half (03) moves.

16. The method according to claim 11,
wherein
when one brewing-chamber half (03) moves, the control elements (12.1) are at least temporarily or partially moved away from each another in the axial direction of the axis (21) when the brewing-chamber halves (02, 03) move from the open position into the closed position and are at least temporarily or partially moved toward one another when the brewing-chamber halves (02, 03) move from the closed position into the open position.

17. The method according to claim 11,
wherein
a substrate portion introduced into a space between the brewing-chamber halves (02, 03) in an otherwise unguided manner when the brewing-chamber halves (02, 03) are open is automatically moved into a defined preparatory position.

18. The method according to claim 11,
wherein
a scraper protrusion (11) protruding downward on the holding structure (08) and/or the control means (12) scrapes downward a substrate portion, which is still located between the brewing-chamber halves (02, 03) when the brewing-chamber halves (02, 03) open, as the holding structure (08) is lowered between the brewing-chamber halves (02, 03).

19. The brewing unit (01) according to claim 1, wherein the beverage preparation device comprises a coffee machine for pre-portioned coffee units.
